(19) United States
(12) Patent Application Publication
(10) Pub. No.: US 2016/0211064 A1
(43) Pub. Date: Jul. 21, 2016

(54) WIRELESS POWER CHARGING APPARATUS USING SUPERCONDUCTING COIL

(71) Applicant: Industry-Academic Cooperation Foundation, Chosun University, Gwangju (KR)

(72) Inventors: HYO SANG CHOI, Gwangju (KR); BYUNG IK JUNG, Gwangju (KR); HYE WON CHOI, Gwangju (KR); IN SUNG JEONG, Gwangju (KR); MIN SANG KANG, Gwangju (KR); YU KYEONG LEE, Jeollanam-do (KR); JUN HYUN PARK, Gwangju (KR)

(73) Assignee: Industry-Academic Cooperation Foundation Chosun University, Gwangju (KR)

(21) Appl. No.: 14/997,512

(22) Filed: Jan. 16, 2016

(30) Foreign Application Priority Data
Jan. 19, 2015 (KR) 10-2015-0008702
Dec. 23, 2015 (KR) 10-2015-0184741

(51) Int. Cl. H01F 6/06; H02J 7/02

(52) U.S. Cl. CPC H01F 6/06; H02J 7/025

(57) ABSTRACT

Wireless power transmitting and receiving apparatuses are described, using a superconducting coil for a resonant coil, and wireless power charging systems using the same. Wireless power charging systems described include a power source, a wireless power transmitter connected with the power source, a wireless power receiver, and a battery connected with the wireless power receiver. The wireless power transmitter includes a source coil connected with the power source, a superconducting transmitting coil into which electricity is induced by a magnetic field generated when electricity flows through the source coil, and a first conductive cooling device connected with the superconducting transmitting coil. The wireless power receiver includes a superconducting receiving coil that uses frequency resonance between the coils, a load coil into which electricity is induced by a magnetic field generated when electricity flows through the superconducting receiving coil, and a second conductive cooling device connected with the superconducting receiving coil.

### CROSS-REFERENCE TO RELATED APPLICATIONS

This application claims priority from Korean Patent Application No. 10-2015-0008702, filed on Jan. 19, 2015, in the Korean Intellectual Property Office, and Korean Patent Application No. 10-2015-0184741, filed on Dec. 23, 2015, also in the Korean Intellectual Property Office The entire contents of said applications are incorporated herein by reference for all purposes.

### BACKGROUND

1. Technical Field

The present invention relates to wireless power charging systems. Specifically, the present invention relates to wireless power transmitting and receiving apparatus, capable of increasing power transmitting efficiency by using a superconducting coil for a resonant coil, and wireless power charging systems using the same.

2. Background Art

Electric vehicles may allow reduction of greenhouse gases compared to existing vehicles using fossil fuel as driving energy, and improvement of living environments since they produce no air pollutants. Also, electric vehicles can save costs of maintenance even when oil price rises due to limitation of fossil fuel. Thus, a demand for electric vehicles is on the rise. However, in order to commercialize electric vehicles, the size and performance of a battery should be secured, an infrastructure for charging should be properly constructed, and issues, such as the time incurred for charging, mileage after charging, electric shock accidents occurring during charging, etc., should be resolved. However, since these issues have not been resolved completely yet, the commercialization of electric vehicles is in an initial stage. One way of resolving these issues is a wireless charging technique using a wireless power transmitting technique. Wireless charging using the wireless power transmitting technique does not cause electric shock accidents during charging, compared to plug-in charging, and simple application of coils facilitates infrastructure construction. Further, when electric vehicles are stopped, when parked, etc., it is possible to charge the vehicles, and time and effort on charging may be reduced.

However, wireless charging is in an initial stage of development, and there is a limitation to a power transmitting distance, and the power transmitting efficiency is significantly changed depending on arrangement of transmitting and receiving coils. Research and development continue to overcome these disadvantages.

3. Prior Arts

### Patent Documents

(Patent Document 1) Korean Patent Laid-Open No. 10-2014-0093348 (Jul. 28, 2014), pages 6 to 9.

### SUMMARY OF INVENTION

Aspects of the present invention relate to wireless power transmitting and receiving apparatuses, capable of increasing power transmitting efficiency by using a superconducting coil for a resonant coil, and wireless power charging systems using the same. The wireless power charging systems according to aspects of the present invention include a power source, a wireless power transmitter connected with the power source, transmitting power wirelessly, a wireless power receiver receiving power from the wireless power transmitter, and a battery connected with the wireless power receiver, charging power. The wireless power transmitter includes a source coil connected with the power source, a superconducting transmitting coil into which electricity is induced by a magnetic field generated when electricity flows through the source coil, and a first conductive cooling device connected with the superconducting transmitting coil, cooling the superconducting transmitting coil. The wireless power receiver includes a superconducting receiving coil with a substantially identical resonant frequency to the superconducting transmitting coil in the wireless power transmitter, receiving power from the superconducting transmitting coil using frequency resonance between the coils, a load coil into which electricity is induced by a magnetic field generated when electricity flows through the superconducting receiving coil, and a second conductive cooling device connected with the superconducting receiving coil, cooling the superconducting receiving coil.

Aspects of the present invention provide a wireless power transmitting and receiving apparatus, capable of increasing power transmitting efficiency by using a superconducting coil for a resonant coil, and a wireless power charging system using the same. Also, embodiments of the present invention provide a wireless power transmitting and receiving apparatus, capable of reducing the size and weight by using a cooling device of conductive cooling type to maintain a superconducting coil in low temperature conditions, and a wireless power charging system using the same.

A wireless power charging system according to embodiments of the present invention includes a power source, a wireless power transmitter connected with the power source, transmitting power wirelessly, a wireless power receiver receiving power from the wireless power transmitter, and a battery connected with the wireless power receiver, charging power, wherein the wireless power transmitter includes a source coil connected with the power source, a superconducting transmitting coil into which electricity is induced by a magnetic field generated when electricity flows through the source coil, and a first conductive cooling device connected with the superconducting transmitting coil, cooling the superconducting transmitting coil, and wherein the wireless power receiver includes a superconducting receiving coil with a substantially identical resonant frequency to the superconducting transmitting coil in the wireless power transmitter, receiving power from the superconducting transmitting coil using frequency resonance between the coils, a load coil into which electricity is induced by a magnetic field generated when electricity flows through the superconducting receiving coil, and a second conductive cooling device connected with the superconducting receiving coil, cooling the superconducting receiving coil.

According to an embodiment, the superconducting transmitting coil may be spirally wound, and the source coil may be arranged to surround the outside of the spirally wound superconducting transmitting coil.

According to an embodiment, the wireless power transmitter may include a first temperature sensor sensing a temperature of the superconducting transmitting coil and a first controller controlling the first conductive cooling device such that the temperature of the superconducting transmitting coil is maintained at a threshold temperature or lower, based on the temperature measured by the first temperature sensor.

According to an embodiment, the source coil may be a superconducting coil, and the first conductive cooling device may be connected with the superconducting source coil and cool the superconducting source coil.

According to an embodiment, the wireless power transmitter may be located under the ground.

According to an embodiment, the superconducting receiving coil may be spirally wound, and the load coil may be arranged to surround the outside of the spirally wound superconducting receiving coil.

According to an embodiment, the wireless power receiver may include a second temperature sensor sensing a temperature of the superconducting receiving coil and a second controller controlling the second conductive cooling device such that the temperature of the superconducting receiving coil is maintained at a threshold temperature or lower, based on the temperature measured by the second temperature sensor.

According to an embodiment, the load coil may be a superconducting coil, and the second conductive cooling device may be connected with the superconducting load coil and cool the superconducting load coil.

According to an embodiment, the wireless power receiver may be located in a lower part of a vehicle.

According to an embodiment, the wireless power transmitter may include a magnetic field shielding layer in its upper part, to shield a magnetic field introduced into the inside of the vehicle.

A wireless power transmitting apparatus according to embodiments of the present invention includes a power source and a wireless power transmitter connected with the power source, transmitting power wirelessly, wherein the wireless power transmitter includes a source coil connected with the power source, a superconducting transmitting coil into which electricity is induced by a magnetic field generated when electricity flows through the source coil, and a first conductive cooling device connected with the superconducting transmitting coil, cooling the superconducting transmitting coil.

A wireless power receiving apparatus according to embodiments of the present invention includes a superconducting receiving coil with a substantially identical resonant frequency to a superconducting transmitting coil in a wireless power transmitter, receiving power from the superconducting transmitting coil using frequency resonance between the coils, a load coil into which electricity is induced by a magnetic field generated when electricity flows through the superconducting receiving coil, and a second conductive cooling device connected with the superconducting receiving coil, cooling the superconducting receiving coil.

According to an embodiment, the source coil, transmitting coil, receiving coil, and load coil, which are used for transmitting wireless power, may be formed of at least one selected from a superconducting coil and a copper coil.

As described above, the wireless power transmitting and receiving apparatus and the wireless power charging system using the same according to embodiments of the present invention may increase a Q-factor value using a superconducting coil with a resistance significantly lower than that of a normal conducting coil at a threshold temperature. Thus, the wireless power transmitting and receiving apparatus and the wireless power charging system using the same according to embodiments of the present invention may have an increased Q-factor, thereby being capable of transmitting wireless power with greater electrical energy.

The wireless power transmitting and receiving apparatus and the wireless power charging system using the same according to embodiments of the present invention use a cooling device of conductive cooling type, thereby being capable of not only maintaining the threshold temperature of the superconducting coil but also reducing the size and weight of the wireless power transmitting apparatus.

The wireless power transmitting and receiving apparatus and the wireless power charging system using the same according to embodiments of the present invention have a compact size and a light weight, which allows easy application to a vehicle and reduction of the size and weight of the vehicle, thereby increasing the efficiency of the vehicle.

### BRIEF DESCRIPTION OF THE DRAWINGS

FIG. 1 is a view illustrating a vehicle adopting wireless power transmitting and receiving apparatus and a wireless power charging system using the same according to an embodiment of the present invention;

FIG. 2 is a view illustrating a wireless power receiving apparatus in FIG. 1;

FIG. 3 is a schematic view illustrating a wireless power transmitting and receiving apparatus and a wireless power charging system using the same in FIG. 1;

FIG. 4 is a view illustrating an S parameter when using a copper coil; and

FIG. 5 is a view illustrating an S parameter when using a superconducting coil.

### DETAILED DESCRIPTION

Hereinafter, a wireless power transmitting and receiving apparatus and a wireless power charging system using the same according to the present invention are described in detail.

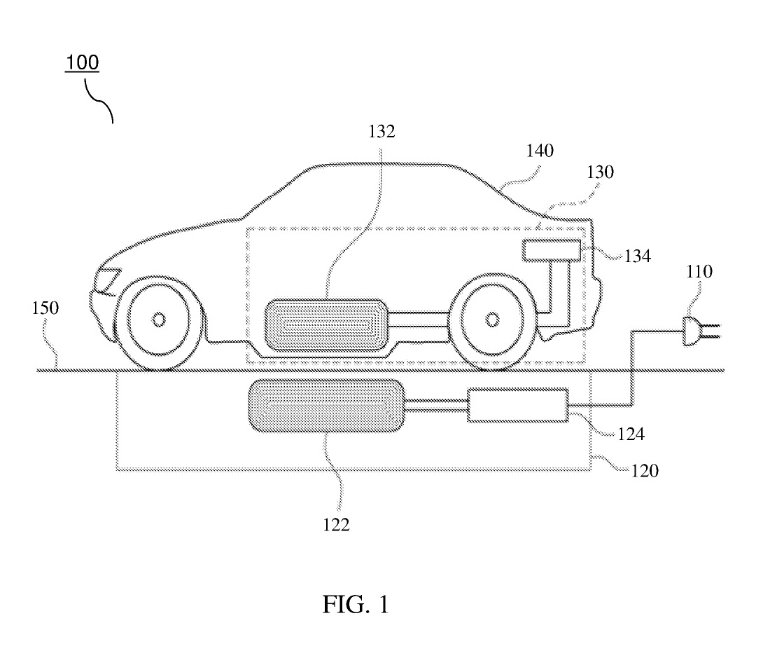

FIG. 1 is a view illustrating a vehicle adopting wireless power transmitting and receiving apparatus and a wireless power charging system using the same according to an embodiment of the present invention.

With reference to FIG. 1, the wireless power charging system includes a power source 110, a wireless power transmitter 120, and a wireless power receiver 130. The wireless power transmitter 120 includes a transmitter coil 122 and a first conductive cooling device 124. The wireless power receiver 130 includes a receiver coil 132 and a second conductive cooling device 134.

The wireless power charging system may include a wireless power transmitting apparatus including a power source 110 and the wireless power transmitter 120, and a wireless power receiving apparatus including the wireless power receiver 130.

The power source 110, which is an external power supplying device, supplies power to the wireless power transmitter 120. According to an embodiment, the power source 110 may be a power grid supplying power to a predetermined region, a smart grid, or an energy storage system (ESS) installed in a predetermined place.

The wireless power transmitter 120 is connected with the power source 110 and transmits power using a magnetic resonance scheme. The transmitter coil 122 generates a magnetic field which vibrates at a resonant frequency and the wireless power transmitter 120 transmits power only to the receiver coil 132 which is designed with the identical resonant frequency. The receiver coil 122 includes a source coil connected with the power source 110 and a superconducting transmitting coil into which electricity is introduced by a magnetic field generated when electricity flows through the source coil. The first conductive cooling device 124 is connected with the superconducting transmitting coil and cools the superconducting transmitting coil so as to maintain the temperature of the superconducting transmitting coil at a threshold temperature or lower.

The cooling scheme of a superconductor is classified into the fluid circulation cooling scheme and the conductive cooling scheme. The fluid circulation cooling scheme is a scheme directly flowing an extremely lower temperature fluid around the superconductor, which secures higher cooling reliability but requires an extremely lower temperature pump, a heat exchanger, etc., for circulating the fluid, and a housing and a sealing for surrounding the superconductor. The conductive cooling scheme is a scheme directly connecting a chiller and a superconductor using a material with higher thermal conductivity, which has cooling reliability lower than the fluid circulation cooling scheme, but has a simple cooling system. The wireless power transmitting and receiving apparatus and the wireless power charging system using the same according to embodiments of the present invention cool the superconducting coil using the conductive cooling device, which allows the reduction of the size and weight of the wireless power transmitting and receiving apparatus and the wireless power charging system using the same, thereby increasing spatial efficiency and energy efficiency of a vehicle.

The wireless power receiver 130 receives power from the wireless power transmitter 120 using a magnetic resonance scheme. The receiver coil 132 includes a superconducting receiving coil with an identical resonant frequency to the superconducting transmitting coil in the wireless power transmitter, receiving power from the superconducting transmitting coil using frequency resonance between the coils, and a load coil into which electricity is induced by a magnetic field generated when electricity flows through the superconducting receiving coil. The second conductive cooling device 134 is connected with the superconducting receiving coil, cooling the superconducting receiving coil, so as to maintain the temperature of the superconducting receiving coil at a threshold temperature or lower.

According to an embodiment, the power received by the wireless power receiver 130 may be supplied to another system (not shown) which is connected with the wireless power receiver 130 to be used, or supplied to a battery (not shown) which is connected with the wireless power receiver 130 to charge the battery.

According to an embodiment, the wireless power transmitter 120 may be located under the ground 150, and the wireless power receiver 130 may be located in a lower part of a vehicle 140. When the wireless power receiver 130 is located in the lower part of the vehicle 140, the wireless power transmitter 120 may include a magnetic field shielding layer in its upper part, to shield a magnetic field introduced into the inside of the vehicle.

When the vehicle 140 including the wireless power receiver 130 is parked or stopped at a region where the wireless power transmitter 120 is installed, once the vehicle 140 is sensed, the wireless power transmitting apparatus may switch the power source 110 to supply power to the wireless power transmitter 120. Thus, the vehicle 140 may be provided with power and charge the battery by simply parking or stopping at a region where the wireless power transmitter 120 is installed. Thus, a charging process may be streamlined and a user may not waste time for charging separately.

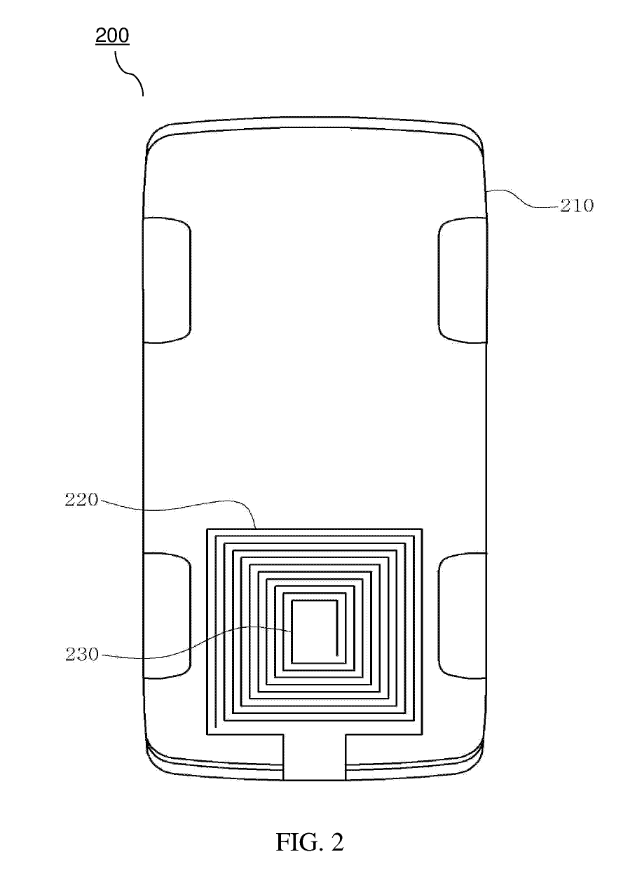

FIG. 2 is a view illustrating a wireless power receiving apparatus in FIG. 1.

With reference to FIG. 2, the receiver coil in the wireless power receiver 130 may be located in a lower part 210 of the vehicle, facing the wireless power transmitter 120. The receiver coil includes a load coil 220 formed of a normal conducting coil such as a copper coil and a superconducting receiving coil 230 formed of a superconducting coil. According to an embodiment, the superconducting receiving coil 230 may be spirally wound, and the load coil 220 may be arranged to surround the outside of the spirally wound superconducting transmitting coil 230. For example, the superconducting receiving coil 230 may be spirally wound in rectangular form, with its one side extending from the inside towards the outside. Further, the load coil 220 may be arranged to surround the superconducting receiving coil 230 in rectangular form, coplanar with the superconducting receiving coil 230, with part of the center of the lower side opened. In the center of the lower side of the load coil 220, an input terminal and an output terminal may be formed to be connected with the battery.

The superconducting receiving coil 230 transmits power to the load coil 220 using a magnetic induction scheme. When electricity flows through the superconducting receiving coil 230 and a magnetic field is generated, electricity is induced into the load coil 220 by the generated magnetic field. The superconducting receiving coil 230 is connected with the second conductive cooling device 134. According to an embodiment, cooling reliability may increase by connecting the superconducting receiving coil 230 with a plurality of conductive cooling devices. For example, cooling reliability may increase by connecting each conductive cooling device with a starting part, a finishing part, and an intermediate part of the superconducting receiving coil 230.

According to an embodiment, the wireless power receiver 130 may further include a second temperature sensor (not shown) sensing the temperature of the superconducting receiving coil 230 and a second controller controlling the second conductive cooling device 134 such that the temperature of the superconducting receiving coil 230 is maintained at a threshold temperature or lower, based on the temperature measured by the second temperature sensor. According to an embodiment, in the wireless power receiver 130, a plurality of temperature sensors may be arranged along the winding path of the superconducting receiving coil 230, to measure temperatures at each part of the superconducting receiving coil 230, and the controller may control one of or a plurality of conductive cooling devices based on the temperatures measured by each temperature sensor.

According to another embodiment, the load coil 220 in the wireless power receiver 130 may be formed of a superconducting coil. In this case, the second conductive cooling device 134 or a separate conductive cooling device may be connected with the superconducting load coil 220, to cool the superconducting load coil 220.

The coil in the wireless power transmitter 120 may be arranged in the same way as the wireless power receiver 130. The transmitter coil in the wireless power transmitter 120 may be located under the ground, facing the wireless power receiver 130. The transmitter coil includes a source coil formed of a normal conducting coil such as a copper coil and a superconducting transmitting coil formed of a superconducting coil. According to an embodiment, the superconducting transmitting coil may be spirally wound, and the source coil may be arranged to surround the outside of the spirally wound superconducting transmitting coil. For example, the superconducting transmitting coil may be spirally wound in rectangular form, with its one side extending from the inside towards the outside. Further, the source coil may be arranged to surround the superconducting transmitting coil in rectangular form, coplanar with the superconducting transmitting coil, with part of the center of the lower side opened. In the center of the lower side of the source coil, an input terminal and an output terminal may be formed to be connected with the power source 110.

The source coil transmits power to the superconducting transmitting coil using a magnetic induction scheme. When electricity flows through the source coil and a magnetic field is generated, electricity is induced into the superconducting transmitting coil by the generated magnetic field. The superconducting transmitting coil is connected with the first conductive cooling device 124. According to an embodiment, cooling reliability may increase by connecting the superconducting transmitting coil with a plurality of conductive cooling devices. For example, cooling reliability may increase by connecting each conductive cooling device with a starting part, a finishing part, and an intermediate part of the superconducting transmitting coil.

According to an embodiment, the wireless power transmitter 120 may further include a first temperature sensor (not shown) sensing the temperature of the superconducting transmitting coil and a first controller controlling the first conductive cooling device 124 such that the temperature of the superconducting transmitting coil is maintained at a threshold temperature or lower, based on the temperature measured by the first temperature sensor. According to an embodiment, in the wireless power transmitter 120, a plurality of temperature sensors may be arranged along the winding path of the superconducting transmitting coil, to measure temperatures at each part of the superconducting transmitting coil, and the controller may control one of or a plurality of conductive cooling devices based on the temperatures measured by each temperature sensor.

According to another embodiment, the source coil in the wireless power transmitter 120 may be formed of a superconducting coil. In this case, the first conductive cooling device 124 or a separate conductive cooling device may be connected with the superconducting source coil, to cool the superconducting source coil.

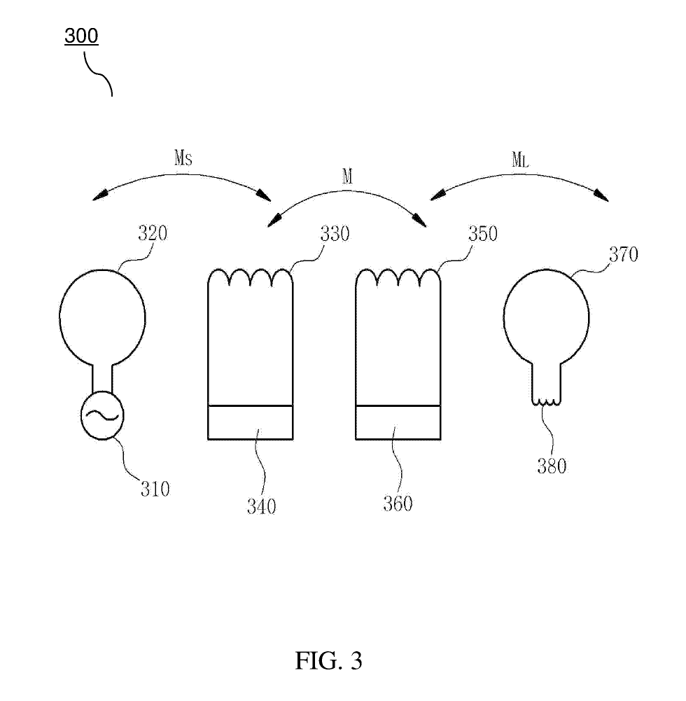

FIG. 3 is a schematic view illustrating a wireless power transmitting and receiving apparatus and a wireless power charging system using the same in FIG. 1

The wireless power transmitting apparatus includes a power source 310 and a wireless power transmitter, and the wireless power transmitter includes a source coil 320, a transmitting coil 330, and a first conductive cooling device 340. According to an embodiment, the transmitting coil 330 may be formed of a superconducting coil. The source coil 320 is connected with the power source 310, and the source coil 320 transmits power to the transmitting coil 330 using a magnetic induction scheme. The transmitting coil 330 is connected with the first conductive cooling device 340, and the first conductive cooling device 340 cools the temperature of the transmitting coil 330 to be a threshold temperature or lower. Ms indicates a mutual inductance value between the source coil 320 and the transmitting coil 330.

The wireless power receiving apparatus includes a wireless power receiver, and the wireless power receiver includes a receiving coil 350, a second conductive cooling device 360, and a load coil 370. The transmitting coil 330 in the wireless power transmitter transmits power to the receiving coil 350 in the wireless power receiver using a magnetic resonance scheme, and the receiving coil 350 transmits power to the load coil 370 using a magnetic induction scheme. According to an embodiment, the receiving coil 350 may be formed of a superconducting coil. The receiving coil 350 is connected with the second conductive cooling device 360, and the second conductive cooling device 360 cools the temperature of the receiving coil 350 to be a threshold temperature or lower. M indicates a mutual inductance value between the transmitting coil 330 and the receiving coil 350, and ML indicates a mutual inductance value between the receiving coil 350 and the load coil 370. A resistance 380 (for example, battery) may be connected with the load coil 370.

A quality factor (Q-factor) value of the wireless power transmitting apparatus and receiving apparatus may be indicated as wL/R, and a resistance (R) value may be significantly reduced by using a superconducting coil for the transmitting coil 330 and the receiving coil 350 (herein, w refers to frequency, and L refers to inductance). Thus, the Q-factor values of the wireless power transmitting apparatus and receiving apparatus may significantly increase and the transmission of wireless power of greater electrical energy may be possible, by using a superconducting coil for the transmitting coil 330 and the receiving coil 350.

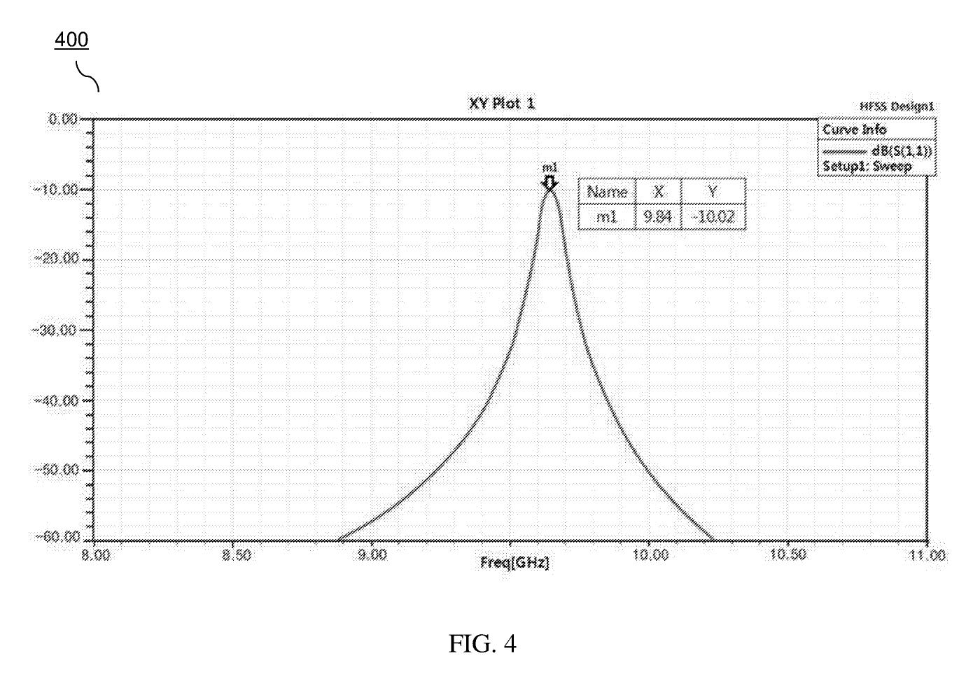

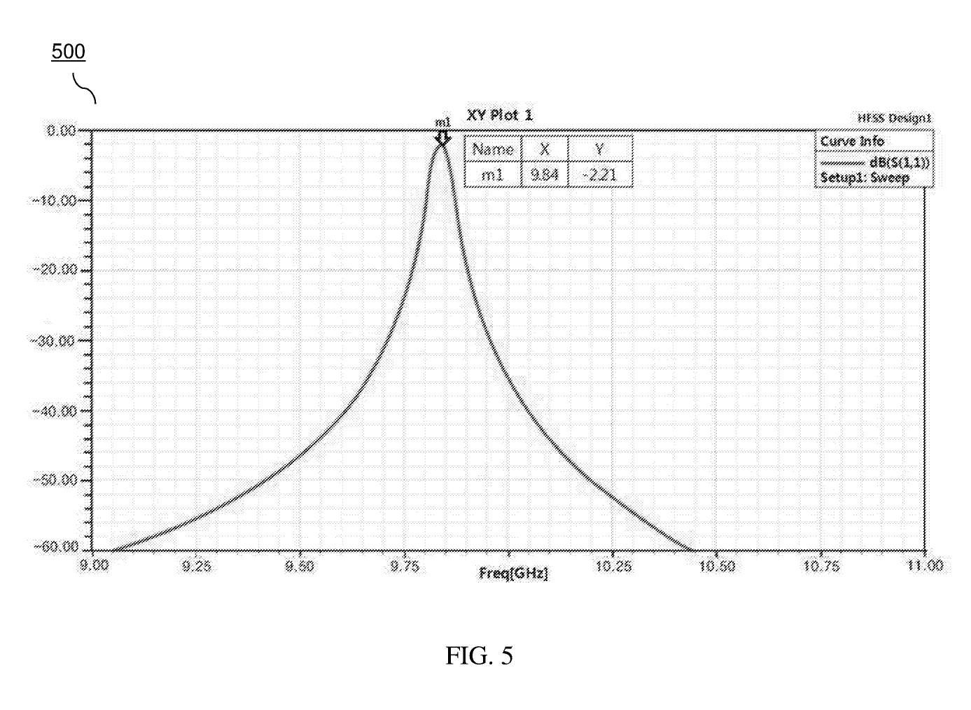

FIG. 4 is a view illustrating an S parameter when using a copper coil, and FIG. 5 is a view illustrating an S parameter when using a superconducting coil.

The S parameter indicates a ratio of an input voltage to an output voltage in the frequency distribution. FIG. 4 is a view illustrating the S parameter when using a copper coil for the transmitting coil 330 and the receiving coil 350 in the wireless power transmitting apparatus and receiving apparatus, and FIG. 5 is a view illustrating the S parameter when using a superconducting coil for the transmitting coil 330 and the receiving coil 350 in the wireless power transmitting apparatus and receiving apparatus.

When comparing FIG. 4 and FIG. 5, the transmitting efficiency when using the copper coil and the transmitting efficiency when using the superconducting coil are 60% and 90%, respectively. Thus, it can be confirmed that the efficiency is very high when using the superconducting coil.

Meanwhile, the source coil, transmitting coil, receiving coil, and load coil, which are used for transmitting wireless power, may be all formed of a superconducting coil or a copper coil, and when the coils are manufactured with the same resonant frequency, a combination of the superconducting coil and the copper coil may be used.

The above embodiments are provided to describe aspects of the present invention. The technical spirit of the present invention is not limited to the embodiments, and various alterations and changes can be made without departing from the spirit of the invention.

What is claimed is:

1. A wireless power charging system, comprising:
a power source;
a wireless power transmitter connected with the power source, transmitting power wirelessly;
a wireless power receiver receiving power from the wireless power transmitter; and
a battery connected with the wireless power receiver, charging power,
wherein the wireless power transmitter comprises:
a source coil connected with the power source;
a superconducting transmitting coil into which electricity is induced by a magnetic field generated when electricity flows through the source coil; and
a first conductive cooling device connected with the superconducting transmitting coil, cooling the superconducting transmitting coil, and
wherein the wireless power receiver comprises:
a superconducting receiving coil with an identical resonant frequency to the superconducting transmitting coil in the wireless power transmitter, receiving power from the superconducting transmitting coil using frequency resonance between the coils;
a load coil into which electricity is induced by a magnetic field generated when electricity flows through the superconducting receiving coil; and
a second conductive cooling device connected with the superconducting receiving coil, cooling the superconducting receiving coil.

2. The wireless power charging system of claim 1, wherein the superconducting transmitting coil is spirally wound, and the source coil is arranged to surround the outside of the spirally wound superconducting transmitting coil.

3. The wireless power charging system of claim 1, wherein the wireless power transmitter comprises:
a first temperature sensor sensing a temperature of the superconducting transmitting coil; and
a first controller controlling the first conductive cooling device such that the temperature of the superconducting transmitting coil is maintained at a threshold temperature or lower, based on the temperature measured by the first temperature sensor.

4. The wireless power charging system of claim 1, wherein the source coil is a superconducting coil, and the first conductive cooling device is connected with the superconducting source coil and cools the superconducting source coil.

5. The wireless power charging system of claim 1, wherein the wireless power transmitter is located under the ground.

6. The wireless power charging system of claim 1, wherein the superconducting receiving coil is spirally wound, and the load coil is arranged to surround the outside of the spirally wound superconducting receiving coil.

7. The wireless power charging system of claim 1, wherein the wireless power receiver comprises:
a second temperature sensor sensing a temperature of the superconducting receiving coil; and
a second controller controlling the second conductive cooling device such that the temperature of the superconducting receiving coil is maintained at a threshold temperature or lower, based on the temperature measured by the second temperature sensor.

8. The wireless power charging system of claim 1, wherein the load coil is a superconducting coil, and the second conductive cooling device is connected with the superconducting load coil and cools the superconducting load coil.

9. The wireless power charging system of claim 1, wherein the wireless power receiver is located in a lower part of a vehicle.

10. The wireless power charging system of claim 9, wherein the wireless power transmitter comprises a magnetic field shielding layer in its upper part, to shield a magnetic field introduced into the inside of the vehicle.

11. A wireless power transmitting apparatus, comprising:
a power source; and
a wireless power transmitter connected with the power source, transmitting power wirelessly,
wherein the wireless power transmitter comprises:
a source coil connected with the power source;
a superconducting transmitting coil into which electricity is induced by a magnetic field generated when electricity flows through the source coil; and
a first conductive cooling device connected with the superconducting transmitting coil, cooling the superconducting transmitting coil.

12. A wireless power receiving apparatus, comprising:
a superconducting receiving coil with an identical resonant frequency to a superconducting transmitting coil in a wireless power transmitter, receiving power from the superconducting transmitting coil using frequency resonance between the coils;
a load coil into which electricity is induced by a magnetic field generated when electricity flows through the superconducting receiving coil; and
a second conductive cooling device connected with the superconducting receiving coil, cooling the superconducting receiving coil.

13. The wireless power charging system of claim 1, wherein the source coil, transmitting coil, receiving coil, and load coil, which are used for transmitting wireless power, are formed of at least one selected from a superconducting coil and a copper coil.
